(19) United States
(12) Patent Application Publication
(10) Pub. No.: US 2020/0163460 A1
(43) Pub. Date: May 28, 2020

(54) BEAD FOAM MOLDED MEMBER FOR VEHICLE SEAT AND CUSHION MEMBER FOR VEHICLE SEAT

(71) Applicant: TOYOTA BOSHOKU KABUSHIKI KAISHA, Aichi-ken (JP)

(72) Inventors: Yuki MIYAWAKI, Aichi-ken (JP); Shinsuke SATO, Aichi-ken (JP)

(73) Assignee: TOYOTA BOSHOKU KABUSHIKI KAISHA, Aichi-ken (JP)

(21) Appl. No.: 16/686,652

(22) Filed: Nov. 18, 2019

(30) Foreign Application Priority Data
Nov. 22, 2018 (JP) 2018-219173

(51) Int. Cl. A47C 7/18; B60N 2/70

(52) U.S. Cl. CPC A47C 7/185; B60N 2/7017

(57) ABSTRACT

A bead foam molded member for a vehicle seat, the bead foam molded member being integrated in a layer shape on a side opposite to a seating surface of a resin foam molded body which is a cushion member of the vehicle seat, wherein the bead foam molded member has at least one bottomed substantially tubular lightening hole extending in a direction towards the seating surface from a surface on a side opposite to the seating surface, and a bottom surface portion of the at least one lightening hole on a seating surface side has a substantially hemispherical surface shape.

### CROSS-REFERENCE TO RELATED APPLICATIONS

This application claims priority from Japanese Patent Application No. 2018-219173 filed on Nov. 22, 2018, the entire contents of which are incorporated herein by reference.

### TECHNICAL FIELD

The present disclosure relates to a bead foam molded member for a vehicle seat and a cushion member for a vehicle seat.

### BACKGROUND ART

In related art, a two-layer pad body is known as a cushion member of a vehicle seat. JP-A-2010-125138 discloses a pad body having a urethane foam surface layer pad obtained by foam molding a polyurethane resin, and a back layer pad which is disposed on a back side of the surface layer pad and is a foam body obtained by foam molding an AS resin (a copolymer of acrylonitrile and styrene). The pad body is configured such that the back layer pad is harder than the surface layer pad and has a lower density than the surface layer pad. Accordingly, it is possible to improve sitting comfort since the surface layer pad which is soft is installed on a front side, and it is possible to reduce weight and improve rigidity of the pad body since the back layer pad which is hard and has a low density is installed on the back side.

In the pad body described in JP-A-2010-125138, one may consider providing a lightening hole in the back layer pad in order to further reduce the weight. However, when the lightening hole is provided without careful consideration, strength or rigidity of the back layer pad is reduced, which may cause damage such as cracks during use.

### SUMMARY

The present disclosure has been made in view of such points, and an object thereof is to provide a bead foam molded member which is light and prevents occurrence of damage such as cracks during use, and a cushion member.

According to an aspect of the disclosure, there is provided a bead foam molded member for a vehicle seat, the bead foam molded member being integrated in a layer shape on a side opposite to a seating surface of a resin foam molded body which is a cushion member of the vehicle seat, wherein the bead foam molded member has at least one bottomed substantially tubular lightening hole extending in a direction towards the seating surface from a surface on a side opposite to the seating surface, and a bottom surface portion of the at least one lightening hole on a seating surface side has a substantially hemispherical surface shape.

Accordingly, since the bead foam molded member has the at least one bottomed substantially tubular lightening hole, a weight thereof can be reduced. Further, since the bottom surface portion of the at least one lightening hole on the seating surface side is formed in a substantially hemispherical surface shape, stress concentration in the bead foam molded member is relieved when a person is seated on the cushion member, and thus, damage such as cracks is difficult to occur.

According to another of the disclosure, there is provided a cushion member for a vehicle seat, the cushion member including: a surface layer pad having a first surface which is a seating surface and a second surface opposite to the first surface; and a bead foam molded member integrated with the surface layer pad, a third surface of the beam foam molded member being in contact with the second surface, and a fourth surface of the beam foam molded member being opposite to the third surface, wherein the bead foam molded member has at least one bottomed substantially tubular lightening hole formed on the fourth surface and extending in a direction towards the third surface, and a bottom surface portion of the at least one lightening hole on a third surface side has a substantially hemispherical surface shape.

### BRIEF DESCRIPTION OF DRAWINGS

FIG. 1 is a perspective view of a cushion pad in which a bead foam molded member for a vehicle seat according to an embodiment of the present disclosure is integrated;

FIG. 2 is an exploded perspective view of the cushion pad according to the embodiment;

FIG. 3 is a plan view of the cushion pad according to the embodiment;

FIG. 4 is a sectional view cut along a line IV-IV in FIG. 3; and

FIG. 5 is a sectional view cut along a line V-V in FIG. 3.

### DESCRIPTION OF EMBODIMENTS

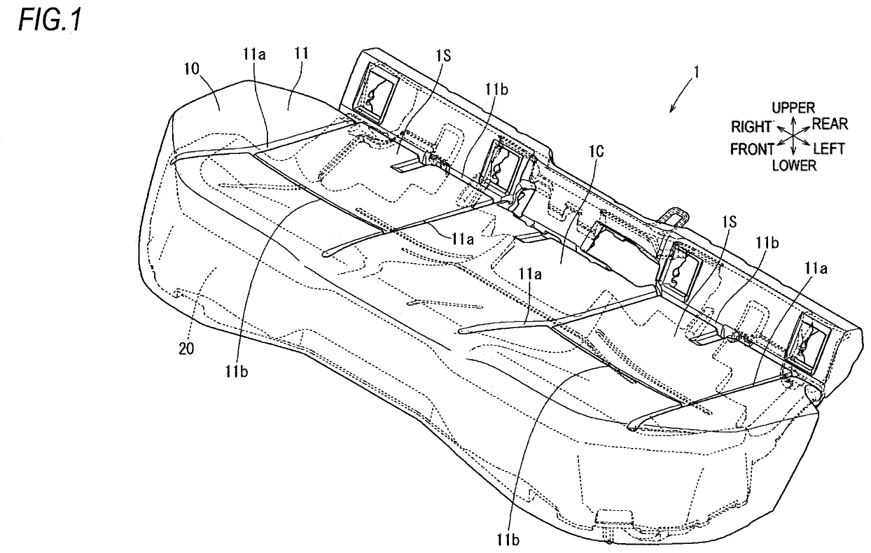

A bead foam molded member 20 according to an embodiment of the present disclosure will be described with reference to FIG. 1 to FIG. 5 together with a cushion pad 1 which is a cushion member of an automobile seat formed by integrating the bead foam molded member 20. In each figure, arrows indicate directions of the automobile and the cushion pad 1 when the cushion pad 1 is attached to a floor of the automobile. In the following description, directions will be described based on the directions defined above.

As shown in FIG. 1, the cushion pad 1 is for a seat cushion of a three-person bench seat, and has a length in a left-right direction substantially the same as a width of a vehicle cabin. A cushion cover (not shown) is covered on the cushion pad 1 to form the seat cushion. A rear seat is configured by combining a seat back (not shown) having a similar configuration as the seat cushion with the seat cushion in a state where the seat back is erected on a rear end portion of the seat cushion and attaching the combined seat back and seat cushion to the vehicle cabin floor. Here, the cushion pad 1 corresponds to the “resin foam molded body” in the claims.

As shown in FIG. 1 to FIG. 5, the cushion pad 1 includes a pair of left and right seat portions 1S and a middle seat portion 1C disposed between the left and right seat portions 1S. The cushion pad 1 includes a surface layer pad 10 disposed on the front side, which is a seating surface side, and a bead foam molded member 20 disposed on the back side, which is a lower side of the surface layer pad 10. Here, the bead foam molded member 20 corresponds to the “bead foam molded member for a vehicle seat” in the claims.

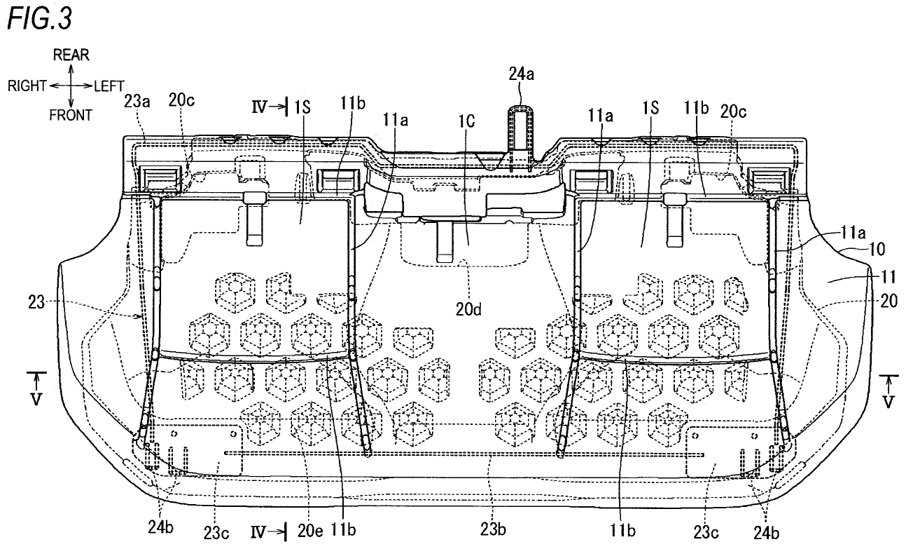

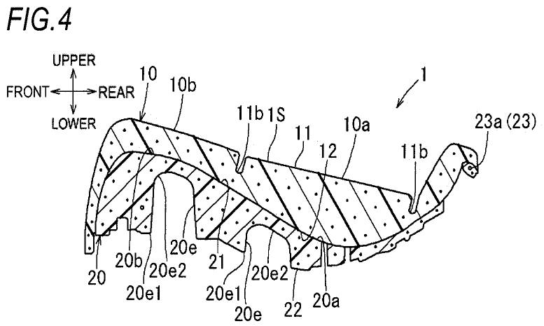

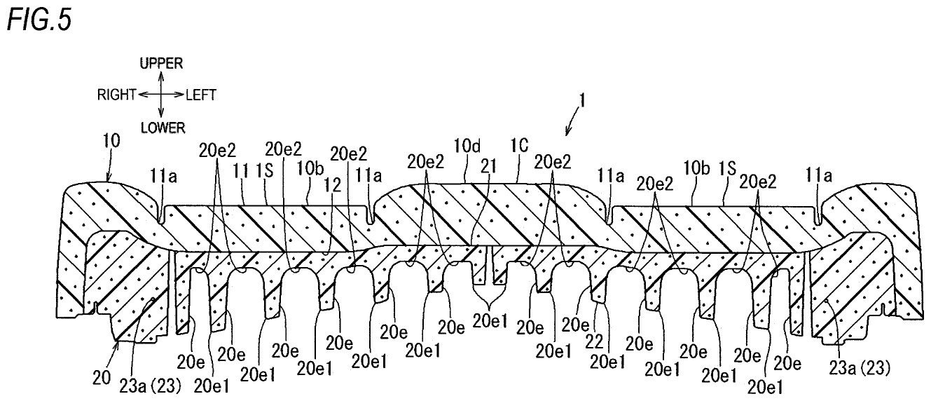

The surface layer pad 10 is formed of urethane foam obtained by foam molding polyurethane resin, and a density thereof is set to, for example, about 0.045±0.005 g/cm3. The surface layer pad 10 includes a surface portion 11 which is a surface of the cushion pad 1 abutting against a body of a seated person, and a back surface portion 12 which forms a part of the cushion pad 1 opposite to the seating surface. In the surface layer pad 10, as shown in FIG. 4, buttock support portions 10a, which support buttocks of seated occupants on the left and right seat portions 1S, are formed thicker than thigh support portions 10b, which support thigh portions of the seated occupants on the left and right seat portions 1S. This is to improve sitting comfort by elastically supporting the buttock support portion 10a having a high sitting pressure than the thigh support portion 10b having a low sitting pressure. In the surface layer pad 10, as shown in FIG. 5, a thigh support portion 10d of the middle seat portion 1C is slightly thicker than the thigh support portions 10b of the left and right seat portions 1S. Although not shown, a buttock support portion 10c of the middle seat portion 1C is formed thinner than the buttock support portions 10a of the left and right seat portions 1S. As shown in FIG. 3, a pair of longitudinal grooves 11a extending in a front-rear direction on left and right of each of the left and right seat portions 1S and two horizontal grooves 11b connecting the pair of longitudinal grooves 11a in both rear end portions and substantially middle portions in the front-rear direction, are formed in the surface portion 11 of the surface layer pad 10. A cross section of the longitudinal grooves 11a and the horizontal grooves 11b are formed in a substantially U-shape opening upward. Here, the surface portion 11 corresponds to the “seating surface” in the claims.

The bead foam molded member 20 is a bead foam molded body of an olefin-based resin such as polypropylene or polyethylene, and has a density of about 0.03 g/cm3. The bead foam molded member 20 is formed to have a smaller density and a higher elastic modulus than those of the surface layer pad 10. A volume of the bead foam molded member 20 is about ⅓ of a total volume of the cushion pad 1.

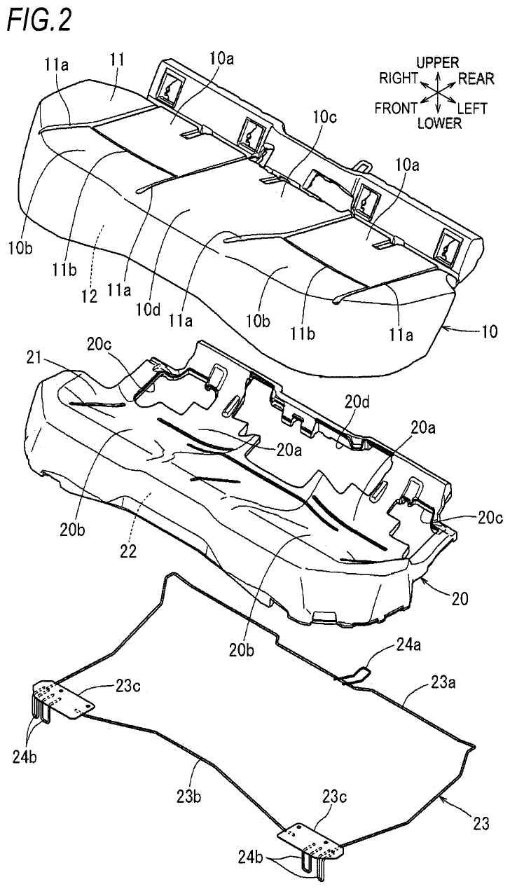

As shown in FIG. 2, FIG. 4, and FIG. 5, the bead foam molded member 20 includes a front side portion 21 that abuts against a part of the back surface portion 12 of the surface layer pad 10, and a back side portion 22 that forms a part of the back side of the cushion pad 1. In the bead foam molded member 20, as shown in FIG. 4, buttock support portions 20a, which support buttocks of seated occupants on the left and right seat portions 1S, are formed thinner than thigh support portions 20b which support thigh portions of the seated occupants on the left and right seat portions 1S. This is for ensuring a predetermined thickness of the cushion pad 1 together with the thickness of the buttock support portions 10a and the thigh support portions 10b of the surface layer pad 10. The bead foam molded member 20 is provided with a pair of left and right through holes 20c penetrating in an upper-lower direction toward outer sides in the left-right direction (width direction) of the rear portion of the left and right seat portions 15. In the bead foam molded member 20, one middle through hole 20d is provided from the rear portion of the middle seat portion 1C toward inner sides in the left-right direction (width direction) of the rear portions of the left and right seat portions 1S. Accordingly, when the surface layer pad 10 is integrally foam molded with respect to the bead foam molded member 20, a part of the surface layer pad 10 enters the left and right through holes 20c and the middle through hole 20d of the bead foam molded member 20 and is molded and cured, and thus a part of the back surface portion 12 of the surface layer pad 10 is exposed. The front side portion 21 of the bead foam molded member 20 is joined to a portion other than the exposed portion of the back surface portion 12 of the surface layer pad 10 at the time of integral foam molding of the surface layer pad 10. Here, the back side portion 22 corresponds to the “surface opposite to the seating surface” in the claims.

As shown in FIG. 3 to FIG. 5, a plurality of lightening holes 20e having a honeycomb in a top view are provided in a portion of the bead foam molded member 20 having a relatively large upper-lower thickness from the front portion of the buttock support portion 20a to the thigh supporting portion 20b. Specifically, the lightening holes 20e aligned in a row in the left-right direction are aligned in four rows in the front-rear direction. The lightening holes 20e are formed in a hexagonal column shape having a hexagonal cross section and extending in the upper-lower direction. Specifically, a lower surface portion of the lightening holes 20e having the hexagonal column shape is formed as a hexagonal opening portion 20e1 opening in the back side portion 22, and the upper surface portion is formed as a spherical surface portion 20e2 whose diameter is a diagonal line of the hexagon and whose shape is a substantially hemispherical shape. Here, the “substantially hemispherical shape” is intended to include not only a case of a perfect hemispherical surface but also a case in which a length of a corner R between a side surface and a bottom surface of the hexagonal column is about ¼ of a length of the diagonal line of the hexagon. A cross section of the hexagonal column is formed such that a size of the hexagon increases gradually and similarly while approaching the opening portion 20e1 in order to facilitate removal of the mold when the bead foam molded member 20 is molded. An upper-lower thickness of the bead foam forming member 20 above the lightening hole 20e is about the same as a thickness of a wall constituting a honeycomb formed between the lightening holes 20e in the top view. The lightening holes 20e located at a terminal portion in the top view among the plurality of aligned lightening holes 20e are cut out according to the shape of the bead foam molded member 20 and may not be hexagonal. In FIG. 3, one lightening hole 20e is representatively denoted by a reference sign to avoid complication of the drawing. Here, the spherical surface portion 20e2 corresponds to the “bottom surface portion” in the claims.

As shown in FIG. 2 to FIG. 5, an iron wire frame 23 is inserted into inner sides of front, rear, left, and right peripheral portions of the bead foam molded member 20. The frame 23 includes a substantially U-shaped main frame 23a opened forward in the top view, a front frame 23b disposed between the opening portions of the main frame 23a, and two plate-shaped coupling frames 23c for coupling the main frame 23a and the front frame 23b. Further, the frame 23 includes one rear locking frame 24a for locking the cushion pad 1 to the vehicle floor, and four front locking frames 24b. An opening portion side end portion of the main frame 23a and the left and right end portions of the front frame 23b are coupled by being welded to the coupling frames 23c. The rear locking frame 24a is fixed to the main frame 23a by welding, and the front locking frame 24b is fixed to the coupling frame 23c by welding. When the bead foam molded member 20 is subjected to bead foam molding, the main frame 23a, the front frame 23b, and the coupling frame 23c formed in a frame shape are disposed at predetermined positions in the mold and are integrally foam molded to be integrated.

The following effects can be achieved by first embodiment configured as described above. The bead foam molded member 20 has the plurality of lightening holes 20e, and the front side portion 21 side of each lightening hole 20e is formed as the spherical surface portion 20e2 having the substantially hemispherical shape. Accordingly, the bead foam molded member 20 can be reduced in weight, and further, when a load is applied to the cushion pad 1 from the seated person, stress concentration on the bead foam molded member 20 around each lightening hole 20e can be prevented, and thus, damage such as cracks is difficult to occur.

In addition, since the plurality of lightening holes 20e are disposed in a honeycomb shape in the top view, it is possible to further reduce the weight while maintaining strength rigidity of the bead foam molded member 20.

Although a specific embodiment has been described above, the present disclosure is not limited to those configurations, and various modifications, additions and deletions are possible without changing the spirit of the present disclosure. Examples thereof include the following.

1. In the above embodiment, lightening holes 20e having a hexagonal cross section was adopted as the lightening holes 20e disposed in a honeycomb-shape in the top view. However, the present disclosure is not limited thereto, and the lightening holes 20e disposed in a honeycomb-shape may be configured by forming the cross section of the lightening holes 20e in an n-angle shape where n is 3 or more, a circular shape, or an oval shape.

2. In the above embodiment, the bead foam molded member 20 was configured as a bead foam molded body of an olefin-based resin such as polypropylene or polyethylene. However, the present disclosure is not limited thereto, and the bead foam molded member 20 can also be configured as a bead foam molded body of a styrene-based resin or a composite resin of a styrene-based resin and an olefin-based resin.

3. In the above embodiment, the present disclosure was applied to a seat cushion for an automobile, but may be applied to a seat back for an automobile, or may be applied to a seat mounted on an airplane, a ship, an electric train, or the like.

The disclosure provides illustrative, non-limiting examples as follows:

According to a first aspect of the disclosure, there is provided a bead foam molded member for a vehicle seat, the bead foam molded member being integrated in a layer shape on a side opposite to a seating surface of a resin foam molded body which is a cushion member of the vehicle seat, wherein the bead foam molded member has at least one bottomed substantially tubular lightening hole extending in a direction towards the seating surface from a surface on a side opposite to the seating surface, and a bottom surface portion of the at least one lightening hole on a seating surface side has a substantially hemispherical surface shape.

According to the first aspect, since the bead foam molded member has the at least one bottomed substantially tubular lightening hole, a weight thereof can be reduced. Further, since the bottom surface portion of the at least one lightening hole on the seating surface side is formed in a substantially hemispherical surface shape, stress concentration in the bead foam molded member is relieved when a person is seated on the cushion member, and thus, damage such as cracks is difficult to occur.

According to a second aspect of the disclosure, there is provided the bead foam molded member for a vehicle seat according to the first aspect, wherein the at least one lightening hole includes a plurality of lightening holes, and wherein the plurality of lightening holes are disposed in a honeycomb shape when viewed from a direction substantially perpendicular to the seating surface.

According to the second aspect, since the plurality of lightening holes are provided in a honeycomb shape, the weight can be further reduced while maintaining strength rigidity.

According to a third aspect of the disclosure, there is provided the bead foam molded member for a vehicle seat according to the first aspect, wherein the at least one lightening hole includes a plurality of lightening holes which are aligned in a row in a left-right direction.

According to a fourth aspect of the disclosure, there is provided a cushion member for a vehicle seat, the cushion member including: a surface layer pad having a first surface which is a seating surface and a second surface opposite to the first surface; and a bead foam molded member integrated with the surface layer pad, a third surface of the beam foam molded member being in contact with the second surface, and a fourth surface of the beam foam molded member being opposite to the third surface, wherein the bead foam molded member has at least one bottomed substantially tubular lightening hole formed on the fourth surface and extending in a direction towards the third surface, and a bottom surface portion of the at least one lightening hole on a third surface side has a substantially hemispherical surface shape.

What is claimed is:

1. A bead foam molded member for a vehicle seat, the bead foam molded member being integrated in a layer shape on a side opposite to a seating surface of a resin foam molded body which is a cushion member of the vehicle seat,
wherein the bead foam molded member has at least one bottomed substantially tubular lightening hole extending in a direction towards the seating surface from a surface on a side opposite to the seating surface, and a bottom surface portion of the at least one lightening hole on a seating surface side has a substantially hemispherical surface shape.

2. The bead foam molded member for a vehicle seat according to claim 1,
wherein the at least one lightening hole includes a plurality of lightening holes, and
wherein the plurality of lightening holes are disposed in a honeycomb shape when viewed from a direction substantially perpendicular to the seating surface.

3. The bead foam molded member for a vehicle seat according to claim 1,
wherein the at least one lightening hole includes a plurality of lightening holes which are aligned in a row in a left-right direction.

4. A cushion member for a vehicle seat, the cushion member comprising:
a surface layer pad having a first surface which is a seating surface and a second surface opposite to the first surface; and
a bead foam molded member integrated with the surface layer pad, a third surface of the beam foam molded member being in contact with the second surface, and a fourth surface of the beam foam molded member being opposite to the third surface,
wherein the bead foam molded member has at least one bottomed substantially tubular lightening hole formed on the fourth surface and extending in a direction towards the third surface, and a bottom surface portion of the at least one lightening hole on a third surface side has a substantially hemispherical surface shape.
